(19) United States
(12) Patent Application Publication
(10) Pub. No.: US 2019/0266163 A1
(43) Pub. Date: Aug. 29, 2019

(54) SYSTEM AND METHOD FOR BEHAVIOR-ON-READ QUERY PROCESSING

(71) Applicant: Interana, Inc., Redwood City, CA (US)

(72) Inventors: Robert Carlton Johnson, Redwood City, CA (US); Oleksandr Barykin, Redwood City, CA (US)

(21) Appl. No.: 16/289,486

(22) Filed: Feb. 28, 2019

Related U.S. Application Data
(60) Provisional application No. 62/636,279, filed on Feb. 28, 2018.

(51) Int. Cl. G06F 16/2455; G06F 16/248

(52) U.S. Cl. CPC G06F 16/24568; G06F 16/24552; G06F 16/248

(57) ABSTRACT

Systems and methods for query processing. An event flow structure is defined, a query is received and interpreted, intermediate calculations are performed, and a query result is calculated.

### CROSS-REFERENCE TO RELATED APPLICATIONS

This application claims the benefit of U.S. Provisional Application No. 62/636,279 filed 28 Feb. 2018, which is incorporated in its entirety by this reference.

### TECHNICAL FIELD

This invention relates generally to the data analytics field, and more specifically to new and useful systems and methods for behavior-on-read query processing.

### BACKGROUND

Businesses today collect huge amounts of data relating to sales, marketing, and other critical operations. Querying this data is often a difficult and resource intensive process, especially for many types of complex queries. To some extent, query performance can be improved by generating data aggregates and indices, but it is infeasible to do this across all dimensions in a large dataset. Because of this, query performance issues often slow data analysis. Thus, there is a need in the data analytics field to create systems and methods for behavior-on-read query processing. This invention provides such new and useful systems and methods.

### BRIEF DESCRIPTION OF THE FIGURES

FIG. 1 is a chart representation of a method of an invention embodiment;

FIG. 2A is an example representation of event flows;

FIG. 2B is an example representation of a definition for a flow structure;

FIG. 2C is an example representation of event data;

FIGS. 2D and 2E are example representations of event flow data;

FIG. 3 is an example representation of a dataset including virtual columns;

FIG. 4A is an example representation of trie-based time bucket caching;

FIG. 4B is an example representation of trie-based time bucket caching; and

FIG. 5 is a diagram representation of a system of an invention embodiment.

### DESCRIPTION OF THE INVENTION EMBODIMENTS

The following description of the invention embodiments of the invention is not intended to limit the invention to these invention embodiments, but rather to enable any person skilled in the art to make and use this invention.

### 1. Introduction

For thousands of years, data analysis was performed by hand (though potentially assisted by adding machines or other calculating devices). While early computers were substantially more sophisticated than, say, Hollerith's “Tabulating Machine” (designed to aid in processing census data in 1890), computers still functioned basically as high-end calculators until the development of the relational database (RDB) and the query language SQL in the 1980s. Suddenly, programmers could ask questions and get answers in return without manually specifying each calculation to be performed, and modern data analytics was born.

Computers have changed a lot since the 80's, but data analytics have failed to evolve in tandem. While the magnitude and speed of data processing today is massively greater than thirty years ago, many data analytics solutions still rely on RDBs, SQL, and highly specialized programmers to glean insights from data. The unfortunate result is that the people most connected to what data means (people like management, sales, marketing) are often disconnected from the people capable of analyzing the data, hamstringing analytical efficiency.

The invention of this disclosure is part of a new paradigm in data analytics. In part enabled by this invention, sophisticated yet surprisingly intuitive data analytics can be performed without specialized programming knowledge.

In particular, one of the greatest drawbacks of traditional data analytics (besides its inaccessibility) is that query performance often relies on data pre-aggregation; unfortunately, the gains realized by pre-aggregation only hold as long as the aggregation performed is valid for the queries being asked. In an ideal world, this might be fine; but in the real world, initial results are more likely to lead to more questions than standing as concrete answers.

In the new paradigm of data analytics, intelligently analyzing behavior during query processing (known as “behavior-on-read”) allows querying, analysis, and iteration to be performed in real-time. The system and method of this disclosure are directed to an invention that supports this paradigm by enabling behavior-on-read processing for event flows: structures that allow users to characterize behavior in an intuitive manner.

### 2. Method

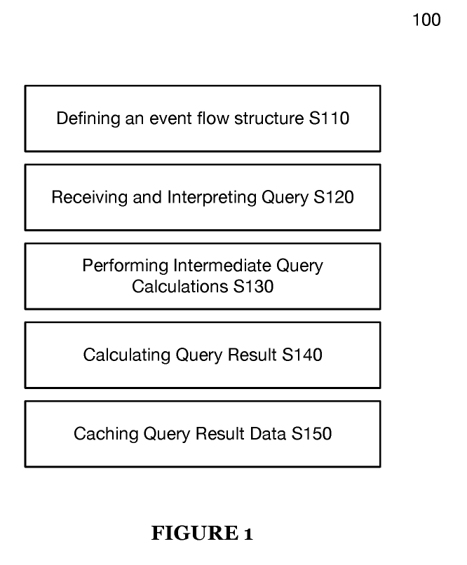

A method 100 for behavior-on-read query processing includes defining an event flow structure S110, receiving and interpreting a query S120, performing intermediate query calculations S130, and calculating a query result S140, as shown in FIG. 1. The method 100 may additionally include caching query result data S150.

The method 100 is preferably operable on the system 200, but may additionally or alternatively be operable on any query processing system capable of executing the method 100.

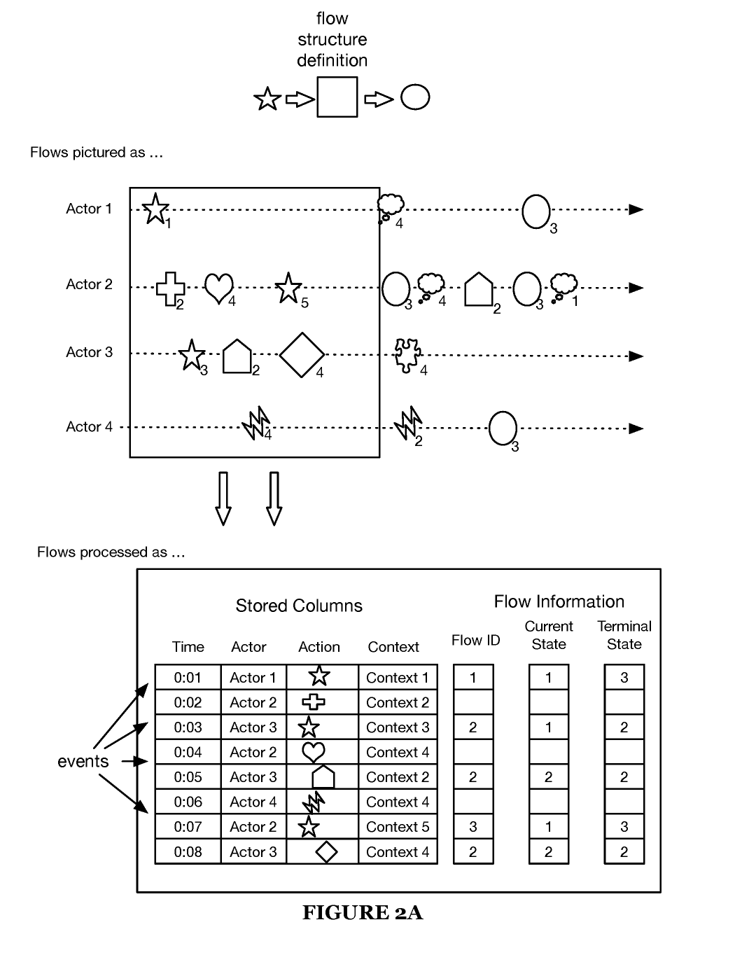

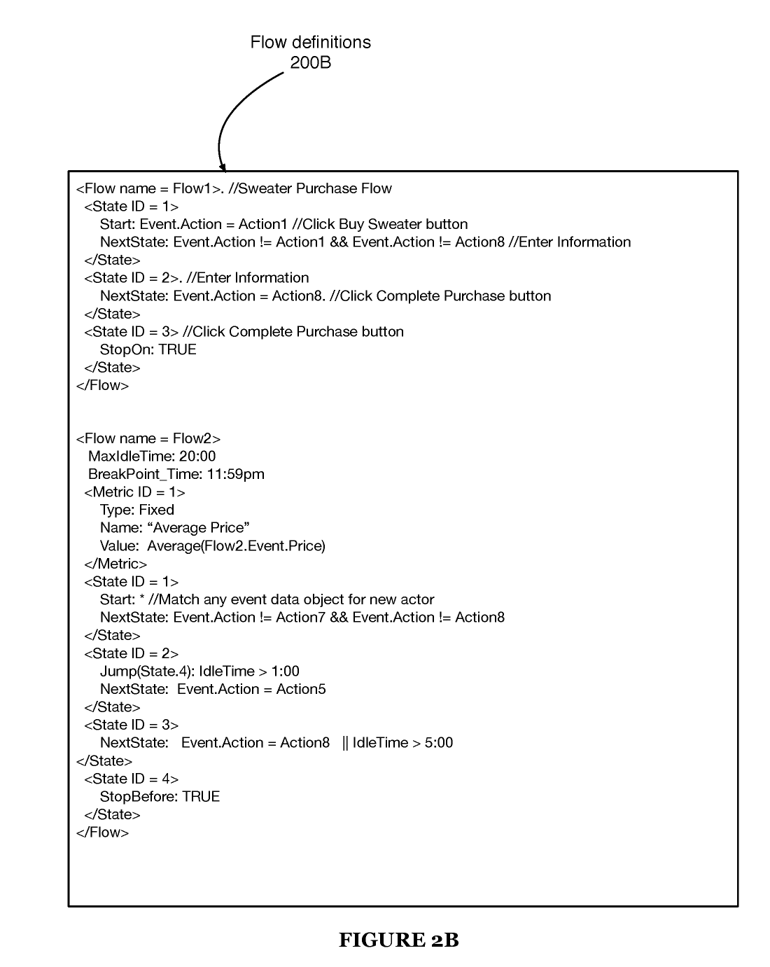

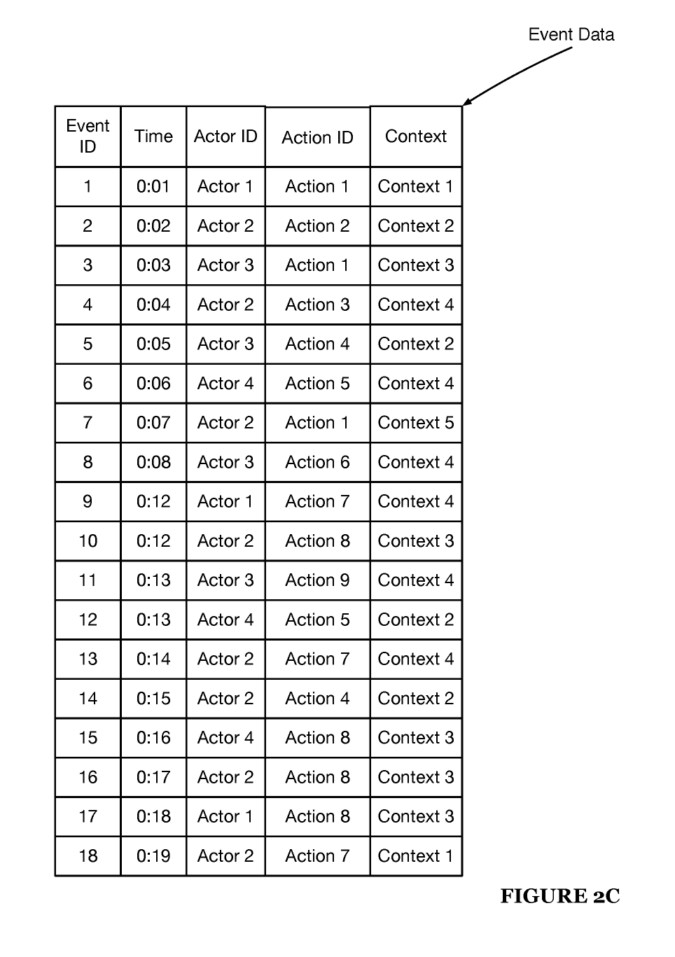

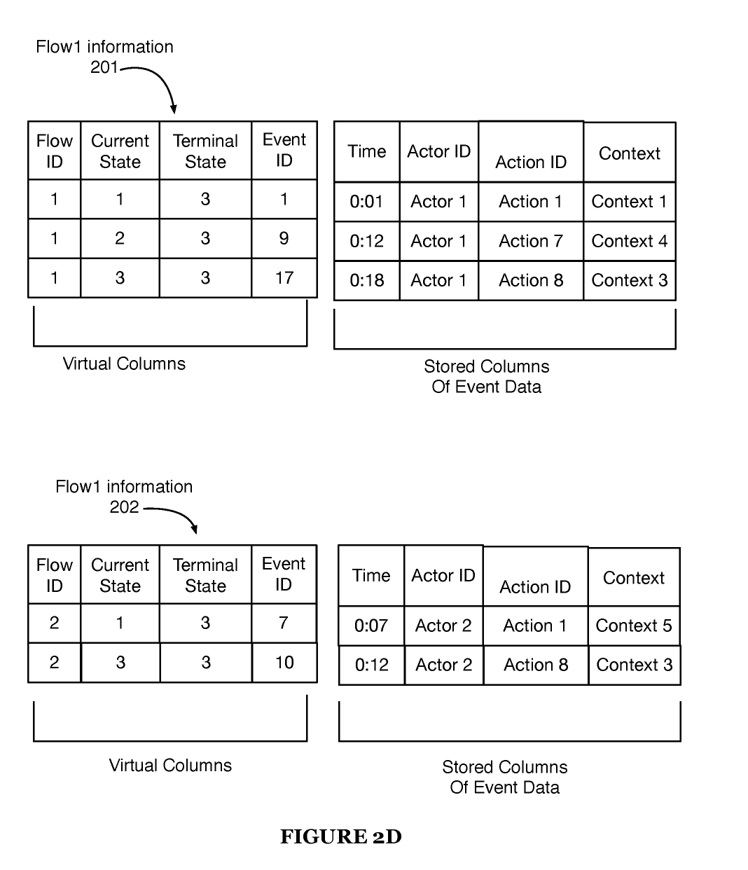

Silo includes defining an event flow structure. As discussed in the introduction, event flows are an intuitive way to describe behavior. Behavioral data is preferably stored by event (e.g., as shown in FIG. 2C), each event associated with a time and an actor (an identifier of the performer of the event or another related entity). In some variations, attributes identifying an action are stored in association with each event. In some variations, context information is also stored with each event. Context information can include, for example, information provided by a user when performing an action, information about the actor, location information, information indicating a device used by the actor, and the like. Flows match events associated with an actor against a series of expected steps and track relevant data (e.g., actor state, time data, and completion status). Flows help users form and test hypotheses about actor sequences and progressions over time (e.g., as they use a service).

Actions can include user inputs received by a web server in a web server session (e.g., registrations, sign-ons, purchases, upgrades, and the like), user inputs received by mobile application via a user interface (e.g., video game telemetry, registrations, sign-ons, purchases, upgrades, downloads, in-app purchases, installation, uninstallation, and the like), user actions performed within a social media network (e.g., content views, likes, uploads, friend requests, posts, comments, and the like).

For example, an example flow structure as shown in FIG. 2 is initiated by a first action (represented by a star), any number (including zero) of intermediate actions, and concluded by a terminal action (represented by a circle). Data tracked (per event) during the example flow includes flow identifier, current state of the actor at that event, and final state of the actor at termination of the flow.

Stated more generally, the flow structure preferably defines parameters for a state machine that transitions from state to state based on a sequence of defined events. This state machine is preferably instanced per actor; alternatively, flows may be instanced in any manner. As events are processed (e.g., during a query), the flow structure provides instructions for when an actor may transition (transition criteria) in state (as well as what data is to be stored related to the flow).

In some variations, a plurality of flow structures can be defined, and an event data object may match starting criteria of more than one flow. In such a case, a new flow is started (flow tracking starts) in accordance with each matching flow structure. In some variations, the flow annotation engine 224 performs flow tracking. Flow tracking includes associating each flow with an actor of the event matching the starting criteria of the flow. For each matching flow structure, flow tracking includes generating a new flow identifier (ID) for the flow and storing flow information for the flow in association with the flow ID. Flow information for a flow can be stored in either a temporary or a permanent memory.

In some variations, flow information is represented as one or more virtual columns (e.g., the flow ID, current state, terminal state, and event ID columns shown for flow information 201-203 in FIGS. 2D-2E).

In some variations, the flow information identifies each matching event data object (e.g., by event identifier) and a corresponding flow state, an actor associated with the event that started the flow, a starting state of the flow, and a stopping state of the flow. In a first variation, the flow information includes a flow starting time, which is a time associated with the event that started the flow. In a second variation, the flow information includes an identifier of the event data object that started the flow (a starting event data object), and the starting time of the flow is determined by accessing the time attribute of the starting event data object from the event database. Flow information can also identify one or more of time between flow states, time spent in each state, and the like.

For each started flow, as event data objects are read from the event database, flow tracking is performed (e.g., by the flow annotation engine 224) by updating the flow information to include information identifying event data objects (e.g., event IDs) matching the flow and information identifying a current state of the flow that corresponds to each matching event data object. In some variations, an event data object matches a started flow if it is an event for the actor of the flow, if the event data object is associated with a time that is greater than the starting time of the flow (and before a stopping time of the flow), and if the event data object attributes match criteria of a state of the flow. Criteria can include specific event data object attributes, or a “match anything” instruction to match any event data object for the actor of the flow that has a time attribute greater than (or equal to) the flow's start time and less than (or equal to) the flow's stopping time. Criteria can include an “ignore” instruction (or filter instruction) that matches all but a set of event data objects that are to be ignored. The flow information can identify a current state of a flow. In some variations, the flow structure definition specifies which types of events trigger a transition (state transition criteria) to a next state of the flow (e.g., “NextState” shown in FIG. 2B). For example, state transition criteria can be specified for one or more states, such that if the flow is in a state having transition criteria and an event data object matches the transition criteria, then the flow transitions to a next state (e.g., a state specified by the transition criteria, a state following the current state as defined by the flow structure definition).

Flow information for a flow includes information of matching event data objects having times greater than or equal to a time associated with a starting of the flow and less than or equal to a time associated with a stopping of the flow. A stopping time of the flow can be determined based on stopping criteria defined for the flow structure for the flow (e.g., stop-on condition, stop-before condition, automatic flow termination condition, flow limit, breakpoint, etc.). The flow information can include data specified by the definition of the associated flow structure, such as, for example, results of flow metrics defined for the flow structure. FIG. 2B shows an exemplary flow structure definition for Flow2 that defines a flow metric (“Average”).

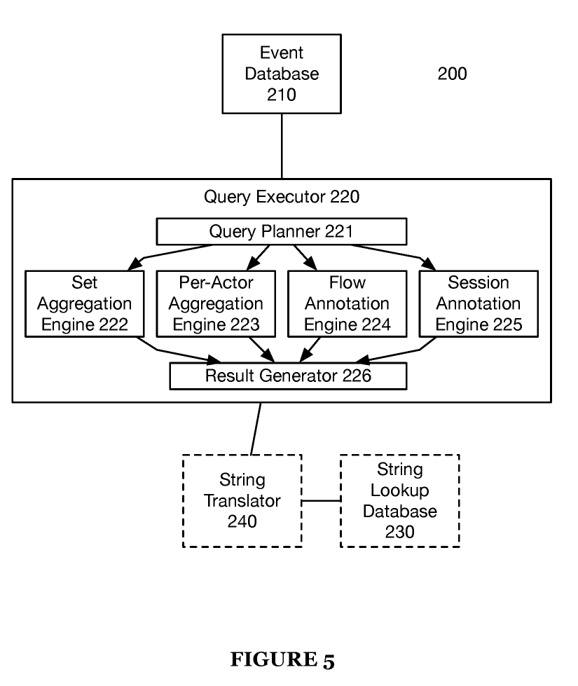

Upon termination of a flow, the flow annotation engine (e.g., 224 shown in FIG. 5) adds information identifying the state at which the flow terminated to the flow information of the flow, and stops flow tracking for the flow. In some variations, the flow annotation engine adds stopping time information to the flow information to the flow. In some variations, the stopping time is a time attribute of an event data object that matches stopping criteria of the flow that resulted in stopping of the flow.

Queries can run on flows by performing operations on flow information generated for flows during flow tracking by the flow annotation engine 224, just as queries can run on data stored in the event database.

In some variations, flow information of one or more flows is provided to a user device, to inform a user of virtual columns and respective values that can be used in forming a query to be executed by the query executor 220.

In some variations, during flow tracking, the flow annotation engine (e.g., 224 shown in FIG. 5) tracks (e.g., by storing in flow information for the flow), for each flow, the last matching state and the time attribute of the event data object matching the last matching state. By tracking last matching state and time of matching for each flow, a time between states can be determined upon transition to a new state. By tracking last matching state and time of matching for each flow, a time spent in the current state can be determined.

In some variations, during flow tracking, the flow annotation engine (e.g., 224 shown in FIG. 5) tracks (e.g., by storing in flow information for the flow), for each flow, a time attribute of the event data object matching the start condition for the flow. By tracking the time at which the flow is started, an elapsed time of the flow can be determined.

For example, if during reading from the event database, an event matches State 1 in Flow 1 that may initialize an instance (a flow) corresponding to the definition of Flow1. Note that “false” is a valid start condition value (e.g., that state will never start a new flow).

Event flow structure definitions define behavior-on-read operations to be performed while reading event data (event data objects) from an event database (e.g., 210 shown in FIG. 5). Behavior-on-read operations may include annotating flow information of a flow (tracking the flow) with additional information upon read. In some variations, the flow information can be stored in the event database, or alternatively, stored temporarily in memory of the query executor. The flow information may be addressable in query expressions or displayed in a graphical user interface as virtual columns, in a similar manner to originally specified columns of the event data in the event database.

In some variations, a query executor (e.g., 220 shown in FIG. 5) reads event data (event data objects) from an event database (e.g., 210 shown in FIG. 5), and a flow annotation engine (e.g., 224 shown in FIG. 5) annotates flow information of one or more flow with additional information in accordance with defined flow structure definitions.

Flow structure definitions (e.g., flow definitions 200b shown in FIG. 2B) set in Silo may include flow states (e.g., states 1-3 for Flow1 shown in FIG. 2B), flow state order (e.g., the order of states 1-3 shown in FIG. 2B), flow limits (stopping criteria), and/or flow metrics. In some variations, flow structure definitions include flow start criteria. A flow start condition can be an instruction to start a flow of the flow structure upon reading a first event object of an actor from the event database. In other words, if a flow structure of having the defined flow structure has not already been started for an actor, such an instruction controls the flow annotation engine 224 to start a new flow having the flow structure. Flow structure definitions may additionally or alternatively include tracking parameters (e.g., current state, terminal state, event ID in current step, flow duration, termination reason) to be tracked during flow processing and stored as flow information for a flow of the flow structure.

FIG. 2B shows an exemplary event flow definition.

Flow state definitions include (for each state within a flow) a state identifier and at least one of a start condition value (starting criteria), state transition criteria (e.g., “NextState”), a stop condition value (stopping criteria), state limits, and jump conditions.

The start condition value specifies conditions in which an event can start a given flow. In some variations, the start condition value is matching criteria that specifies at least one event attribute, and upon reading an event data object whose attributes match the expression, a new flow is started in accordance with the flow definition related to the start condition value.

In some variations, the stop condition value is a flag (e.g., TRUE or FALSE), and upon entering a state having stop condition value indicating that the state is a stopping state, the flow is stopped.

Stop conditions can specify that the flow stops after completing a state designated as a stopping state, or that the flow stops before entering the stopping state. As shown in FIG. 2B, flow 1 stops if the flow transitions to state 3.

State limits specify events (or other parameters, such as idle time) that cause the flow to transition from the current state to the next state (as defined by the flow state order). As shown in FIG. 2B, flow 2 transitions from State 3 to State 4 if IdleTime is greater than five minutes, as specified by “NextState”.

Finally, jump conditions specify events (or other parameters, such as idle time) that cause the flow to transition from the current state to any arbitrary state (specified by state identifier). As shown in FIG. 2B, flow 2 transitions from State 2 to State 4 if IdleTime is greater than one minute, as specified by the jump condition “Jump(State.4)”.

While flows may be limited by some of the per-state parameters discussed in the preceding paragraphs, flow structures may also define global flow limits not tied to an individual state. For example, flow limits may include the maximum number of state transitions, events, or total amount of idle time allowed before flow termination. A specific example of a flow limit is a flow breakpoint—an event time at which flows are automatically terminated (e.g., every 24 hrs after the Unix epoch). Flow breakpoints are particularly unique to the method 100 (and system 200); in contrast to traditional query systems (which typically perform processing starting an arbitrary time based on the particular query), flow calculations may be performed on uniform blocks of time. The result is that (unlike in traditional query systems) changing timing details in the query does not necessarily change how flows are processed. For example, if a query attempts to analyze behavior from 4 PM on October 1st to 7 PM on October 3^{rd}, instead of processing flows on exactly data between these intervals, flow calculations may instead be performed on events from 12 AM October 1st to 11:59 PM on October 3^{rd}, breaking flow every 24 hrs (so covering three time periods). This makes calculations performed in flow processing deterministic for every event, and enables the calculation results to be cached. While flow breakpoints are preferably specified by time, they may additionally or alternatively be specified by a particular event or sequence of events.

As shown in FIG. 2B, flow 2 is automatically terminated if an event data object is read that has a time attribute that has a time of day greater than 11:59 pm.

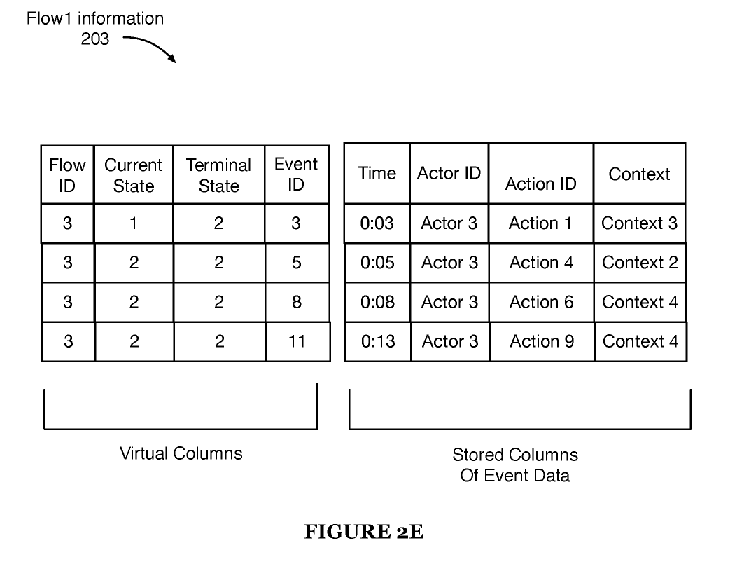

Flow metrics specify calculations to be performed during and/or after flow processing. Flow metrics may be of multiple types, including fixed (a single value for the whole flow, set when all events in the flow are processed; e.g., average sale price for a series of sales events), cumulative (a metric that updates from an initial value to a final value as events move forward in time; e.g., total sales at the time of each event for the same series of sales events), and reverse cumulative (a metric that updates from an initial value to a final value as events move backward in time; e.g., sales revenue not yet captured in the flow after an event). These examples are as shown in FIG. 3. Flow information of a the flow can include results of flow metrics calculated for the flow (and added to the flow information by the flow annotation engine), as defined in the corresponding flow structure definition.

Flows are preferably tracked using virtual columns (e.g., the current state, terminal state, and flow ID columns shown in FIG. 2D); that is, columns not present/stored in an initial dataset (but addressable in a similar manner to originally specified columns). Additionally or alternatively, flow data may be tracked in any manner.

FIG. 2B shows an exemplary flow definition 200B. FIG. 2C shows exemplary event data objects stored in the event database. The event data objects shown in FIG. 2C correspond to the events shown in FIG. 2A. FIGS. 2D-E show data for exemplary flows 201-203 generated by the flow annotation engine for actors 1, 2 and 3, respectively, by processing the event data objects shown in FIG. 2D in accordance with the flow definition Flow1 shown in FIG. 2B.

As shown in FIG. 2B, Flow1 has three defined states, and each state includes an expression to be matched with an event stored in an event database, such as the exemplary event database shown in FIG. 2C.

For example, state 1 of Flow1 has a start condition that matches an event whose action is Action1. Flow 1 can be started in State 1 if an event in the event database has Action 1 as an action. In some variations, a flow definition can specify a start condition for several flow states, meaning that a flow can start in any one of several states.

State 3 of Flow1 has a “TRUE” stop on value, meaning that Flow 1 can be stopped if the flow transitions to State 3. In some variations, a flow structure definition can specify a stop condition value (stop on or stop before) for several flow states, meaning that a flow can be stopped upon transitioning to any one of several states.

Start conditions, state flow limits, and jump conditions, as described herein, can specify matching criteria that matches an event action, an event actor, an event context, an event time, or any other suitable event attribute.

In some variations, Silo includes providing a flow definition user interface to a user device via a network (e.g., by using an application server of the system 200), and receiving user input defining an event flow structure. The flow definition user interface may include one or more user interface elements for receiving user input defining an event flow structure, which is then provided to the system 200 via the application server. In response to the application server 200 receiving the user input for the event flow structure, the event flow structure definition is stored at the system 200 (e.g., at the event database 210, the query executor 220, etc.). The user input for the event flow structure may specify one or more of: a flow metric, a flow breakpoint, a flow jump condition, a start condition, a state flow limit, a global flow limit, a jump condition, and flow tracking parameters.

S120 includes receiving and interpreting a query. S120 functions to convert a query from a user into a set of instructions capable of providing a query result.

Queries may include event data sources, time ranges, filters, partition functions, and metric functions. Event data sources are preferably references to event data fields in an event database; for example, “e.sweater_id” might refer to an event data field corresponding to a type of sweater sold. Time ranges are ranges of time over which a query should be searched; queries preferably ignore event data for which the “e.time” value is outside the specified time ranges. Filters preferably allow data to be included or excluded from a query based on a filtering condition; filters are preferably applied to any event data that satisfies the time ranges, but may additionally or alternatively be applied to any other event data. Any event data that does not satisfy the filters is preferably excluded from query results. In this way, the time range is preferably similar to other filters, except in that the time range preferably has higher priority than other filters. For example, if a set of filters includes a filter that states “e.sweater_id>10”, “Filter(e)” would return “False” for any events “e” with “e.sweater_id<10”. Partition functions are preferably evaluated for any event data that satisfies both time ranges and filters, but may additionally or alternatively be applied to any other event data. Partition functions preferably group events together by satisfaction of one or more relations. The partition function preferably returns all events that satisfy the partition function; for example, “partition(e.sweater_id,23)” would return all events containing that satisfy “e.sweater_id=23”. Metric functions preferably produce statistical data from partition functions. Metric functions preferably include functions that produce a sum, percentile, proportion and/or percentage of event data that satisfies a given condition. If the results of a partition function are interpreted as a representative sample from a broader population, metrics may be considered as sample-based estimates of the corresponding broader population metrics.

Interpreting the query preferably includes first pre-processing the query, which can include parsing the query and translating strings in the query to integers. Translating strings in the query to integers preferably includes passing the string (and potentially other data, such as the referenced data field) to a database containing a mapping of strings to identifiers (e.g. a string lookup database). Pre-processing may additionally or alternatively include performing user authentication, user-friendly string resolution (e.g. resolving “now” into a current timestamp), and parsing SQL-like query strings into a query tree. Pre-processing preferably also includes resolving where data relevant to the query resides (either via calculation or a lookup to a configuration database), performing error handling, scaling, table joins, and/or any math necessary to evaluate the query.

S120 may additionally include specifying or selecting grouping and/or ordering functions. Ordering functions preferably allow for ordering of query results. Ordering functions are preferably applied to final results, but may additionally or alternatively be applied to intermediate results (for example, if ordered results are necessary for a calculation in a query step). Grouping functions preferably allow for grouping of query results. Similar to ordering functions, grouping functions are preferably applied to final results, but may additionally or alternatively be applied to intermediate results. Grouping functions may additionally include cohort functions. Cohort functions are a specific case of grouping functions that divide a population of objects into a set of cohorts, with each object appearing in exactly one cohort.

Based on the query, S120 may include performing query planning; e.g., setting query data sources and execution parameters. For example, if operable on a sharded dataset, query planning may include shard selection. As other examples, query planning may include column selection (set of columns required to perform query), time selection (amount of event data required to perform query), query expansion (some queries may require multiple passes; query expansion determines and sequences required passes), and/or query combination (optimizing multi-pass queries to remove redundancy).

In one implementation of an invention embodiment, multi-pass queries are performed as described in U.S. patent application Ser. No. 14/644,081, the entirety of which is incorporated by this reference. In this implementation, on the first pass, the query preferably takes small samples from a large number of data shards in the event database simultaneously. The query preferably then performs intermediate calculations on the samples to identify or refine potential query results. This set of potential query results is then used as input for a next pass. The next pass may be another identification/refining pass (similar to the first pass, but with a different input), or the next pass may be a final pass. The final pass preferably includes full scans of data shards containing suspected relevant information to the query, but may additionally or alternatively include only partial scans of data shards. Query results are preferably calculated from the results of the final pass.

Note that S120 may include identifying virtual columns (flows) in queries (based on named expressions).

In some variations, identifying virtual columns in queries includes identifying named expressions in queries that match one or more virtual columns. In some variations, the query executor selects at least one virtual column for at least one flow structure definition based on at least one named expression included in the query. In some variations, the query executor selects at least one virtual column for at least one flow structure definition that specifies matching criteria for an event action identified in a named expression of the query. For example, a named expression that identifies Action1 and Action8 may match Flows shown in FIG. 2B.

In some variations, flow information of a flow can be referenced in a query as a virtual column. In some variations, a query can identify virtual columns for Flow Identifer, Flow Current State, and Flow Terminal State. For example, the received query can be a query for a number of users who completed a purchase of a sweater in January 2019 after initiating a purchase. Such a query can reference a virtual column in a sweater purchase flow structure (e.g., SweaterPurchaseFlow as shown in FIG. 2B) that defines a state for the following actions: ClickBuySweaterButton, EnterInformation, ClickCompletePurchaseButton. An exemplary representation of such a query (Query Example 1) could be: Count(SweaterPurchaseFlow.Terminal_State==“ClickCompletePurchaseButton”, StartDate==1/1/2019, StopDate==1/31/2019).

S120 may plan a query such that virtual columns (flow information) are computed (e.g., flows are tracked) before other parts of a query that depends on it. If that named expression is defined in terms of other named expressions, then those need to be computed in earlier passes (and so on). S120 may create a sequence of calls to scan engines (which ingest data) that unwind all the named expressions in the query. Results from earlier passes are used as input for later passes. The final pass computes the top level measure requested in the query builder.

A virtual column identified in a query received at S120 can correspond to a flow structure for which flows have already been started (and possibly stopped), each flow having flow information, and such flow information can be cached either in volatile storage (e.g., memory) or a non-volatile storage (e.g., hard disk, solid state drive, flash drive, and optical storage device and the like). Alternatively, a virtual column identified in a query received at S120 can correspond to a flow structure for which no flows have been started, such that there is no flow information for the flow structure. In some variations, the query can include identifiers for virtual columns for several flow structures, or alternatively, can include an identifier of a virtual columns of a single flow. In a first variation, virtual column identifiers of at least one flow are received via a user interface and used to generate the query. In a second variation, virtual column identifiers of at least one flow are received via a natural language processor that receives a natural language query via a user interface; the natural language processor selects at least one virtual column of at least one flow structure definition based on at least one keyword included in the natural language query; and the natural language processor provides data of the selected virtual column to the a query executor (e.g., 220). In some variations, virtual column identifiers identify the corresponding flow structure definition (e.g., “SweaterPurchaseFlow.Terminal_State”).

S130 includes performing intermediate query calculations. S130 functions to perform calculations necessary to produce the query result in S140. Intermediate query calculations may be initial estimates of query results (e.g., as in the multi-pass query execution scheme); additionally or alternatively, intermediate query calculations may be performed as part of flow tracking (or for any other reason).

In some variations, S130 includes identifying, in the received query, a reference to a defined event flow structure. The reference can be an explicit reference, such as, for example an identifier of the flow structure, or, alternatively, an implicit reference, such as, for example, a named expression that matches at least one aspect of the flow structure.

For example, if a query references a virtual column of a particular flow structure (e.g., “SweaterPurchaseFlow.Terminal_State”), S130 may include tracking flows satisfying that flow structure within the query data (e.g., by using the flow annotation engine 224). Flow tracking preferably includes reading event data from the event database (e.g., 210) and generating flow information for matching flows according to flow structure definitions (as described herein) (preferably using virtual columns, but additionally or alternatively in any manner). In some variations, the tracking is performed in accordance with starting criteria and the stopping criteria of the flow structure. Tracking of a new flow of the flow structure begins when the starting criteria is satisfied, and tracking for the new flow ends when the stopping criteria is satisfied. Note that in some cases, flow tracking data (e.g., flow information) may be cached from previous queries; in this case, cached values may be used rather than re-computing the values.

In some variations, S130 includes providing flow tracking data (e.g., flow information) to a user device either as an object (e.g., a JSON object, XML object, and the like) or via a graphical user interface, prior to calculation of the query result. Reverting to the sweater purchase flow structure, performing intermediate query calculations can include generating flow information (e.g., 201-203 of FIGS. 2D-E) in accordance to the SweaterPurchaseFlow structure, and flow information corresponding to each of the virtual columns Flow ID, Flow Current State, Flow Terminal State can be displayed in a graphical user interface provided to a user device via a network (e.g., the Internet, a local network, a WAN, and the like). The displayed data of the Flow Terminal State virtual column can display the terminal state of each flow. The displayed flows can include flows of different actors purchasing sweaters, and/or flows for separate sweater purchase transactions from the same actor. For each flow, the displayed data can include event attributes of the events of the flow and the terminal state of the flow.

FIG. 2A shows graphical display of flow information, such as information displayed in a graphical user interface of a user device. As shown in FIG. 2A, the star can represent, for example, clicking a sweater buy button, which matches State 1 of the Sweater Purchase Flow. The square can represent any action that is not a click of a sweater buy button and not a click of a complete purchase button, which matches State 2. The circle can represent a click of a complete purchase button, which matches State 3. As shown in FIG. 2A, during processing of the query for a number of users who completed a purchase of a sweater in January 2019 after initiating a purchase, a graphical user interface is generated (and presented to a user device) that displays values of the SweaterPurchaseFlow.Terminal_State virtual column, (shown as <FunnelName.terminal_state> in FIG. 2A) for each event read from the event database. As shown in FIG. 2A, each SweaterPurchaseFlow.Terminal_State virtual column value is displayed in a row that displays event attributes for the corresponding event. Although the user interface shown in FIG. 2A does not display the final query result, it does display intermediary results used in calculating the final query result. These intermediate results can be used to inform further queries. For example, observing the information displayed in FIG. 2A, one may notice that a flow that includes an action represented by a diamond started the SweaterPurchaseFlow, but did not complete the flow. This observation might prompt a user to generate a query that asks how many flows with the action represented by the diamond resulted in completion. Such a query could be formulated by generating an updated SweaterPurchaseFlow structure, e.g., SweaterPurchaseFlow2 that defines a state for the following primary actions: State1=ClickBuySweaterButton, State2=EnterInformation, State3=DiamondAction, and State4=ClickCompletePurchaseButton. An exemplary representation of such a query (Query Example 2) could be: Count(SweaterPurchaseFlow2.Terminal_State==“ClickCompletePurchaseButton” && SweaterPurchaseFlow2.Curent_State==“DiamondAction”, StartDate==1/1/2019, StopDate==1/31/2019). As described herein, upon termination of a flow, the flow annotation engine 224 generates flow information indicating the terminal state. During the flow, flow information indicating the current state is generated, so that when the flow is terminated, information indicating the terminal state is included in the flow information. As a result, after flow annotation by the annotation engine 224, flow information for a flow can include information indicating a current state corresponding to the time attribute of the event data object, as well as the termination state at the time at which the flow terminates. By virtue of the foregoing, queries such as the Query Example 2 can be formed to determine whether flows that entered a given state resulted in completion by accessing only data generated during flow annotation.

S140 includes calculating a query result. S140 functions to determine final query results based on the intermediate calculations of S130, such as flow information generated at S130 in accordance with flow structure definitions. S140 may additionally or alternatively include returning a confidence interval, confidence level, or other estimation of the accuracy of the final query results.

S150 includes caching query result data. S150 functions to cache data resulting from the query execution process. While this data may include final query results, it may additionally or alternatively include any data for which caching is desired. In particular, S150 may include caching virtual column data (flow information) corresponding to flows referenced or otherwise utilized during query execution.

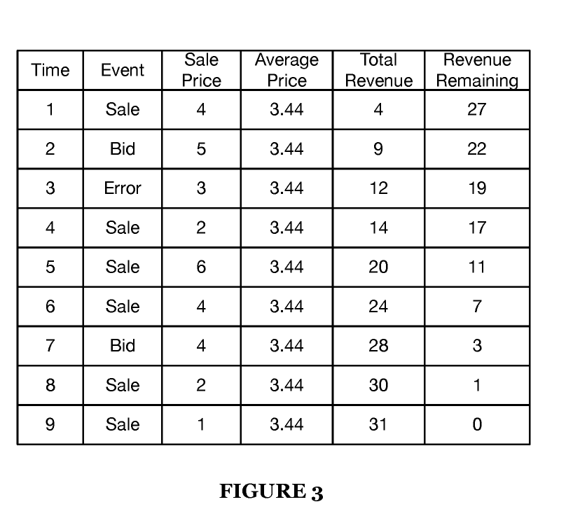

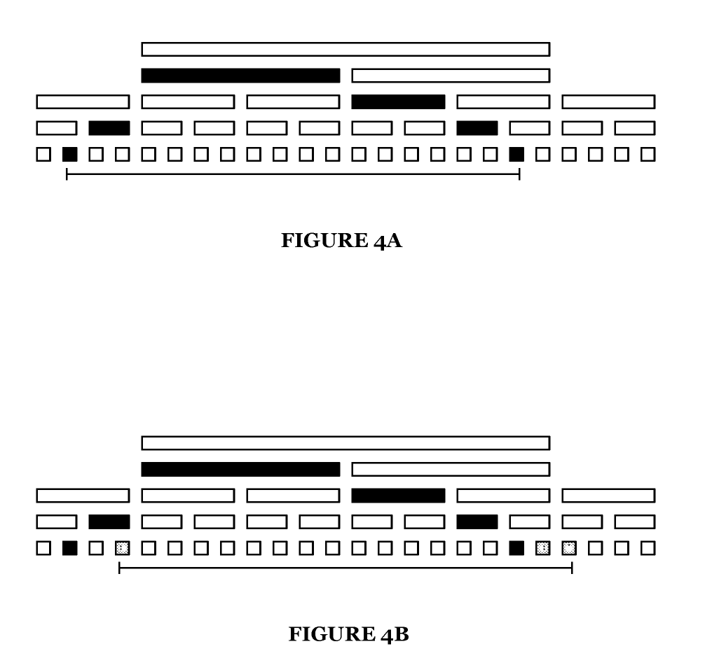

S150 may include caching different types of data in different manners. For example, S150 may include caching flow data (flow information) corresponding to folder (discussed in greater detail in the system description). Alternatively, S150 may include caching query results or other data (e.g., data aggregates) using an adaptive trie technique. In this technique, aggregates are stored according to a geometric function (e.g., factor of 2). For example, if a query is performed for a time interval of 18 time units (where the minimum caching value is one time unit), aggregates as shown in FIG. 4A may be cached (from left to right, one unit aggregate, followed by a two unit aggregate, followed by a eight unit aggregate, a four unit aggregate, a two unit aggregate, and another solo unit). This trie structure provides substantially greater robustness to time shifts within a period (meaning it is easier to reuse caches) compared to a single or few aggregates across a time period while still maintaining a reasonable number of time buckets (on the order of log[n], where n is the number of time units with the query interval). For example, as shown in FIG. 4B, moving the query interval by two time units requires only three new calculations (as shown, stippled).

S150 may additionally or alternatively include caching data in any manner.

### 3. System

As shown in FIG. 5, a system 200 for rapid data analysis includes an event database 210, and a query executor 220. The system 200 may additionally or alternatively include a string lookup database 230 and a string translator 240. In some variations, the system 200 includes an application server that is configured to provide at least one user interface to a user device via a network. User interfaces can include a query execution user interface and a flow definition user interface.

The event database 210 functions as the main information store for the system 200. The event database 210 preferably stores event data, e.g. data that includes a time element or other indication of event order. The event data preferably has at least an associated time field and an actor field, but may contain any suitable set of fields. The event database 210 may additionally or alternatively store any suitable data in any suitable organizational schema. The event database 210 preferably includes multiple datasets to store data in different ways. For example, one dataset may include a list of events grouped (e.g., sharded) by user-id (UID) and organized by time; while another dataset may include the same list of events, but grouped by IP address and organized by time. Data sharding is preferably used to partition and/or group data, but data may additionally or alternatively be grouped in any suitable manner. Different datasets may store identical data, as in the above example, but different datasets may also store different subsets of the same data, or different data entirely. For example, one dataset may include a list of events grouped by UID and organized by time, where the events also include IP address and location fields. A second dataset may include a list of the same events, grouped by IP address and organized by time, but the event information does not include a location or UID. The event database 210 preferably organizes all datasets as columnar datasets; alternatively, datasets may be organized in any suitable manner. Datasets stored in a columnar format preferably use columnar compression to reduce the size of data stored. Columnar compression preferably includes any technique using the sequential nature of data stored in columns to save space.

The event database 210 preferably allows the storage of both explicit and implicit data. Implicit data preferably includes implicitly attached object data sources and may be referenced in queries. For example, in an event stream of sweater sales data, each event could carry explicit data fields that identify the merchant (“e.merchant_id”), terminal (“e.terminal_id”), dollar amount of the transaction (“e.dollar_amount”), and the sweater type sold (“e.sweater_id”). Each event may also have object data sources or other types of implicit data that associate with these explicit data fields; for example, there may be an object data that associates with each “e.sweater_id” properties relating to the sweater type, like size (“sweater_size”) and color (“sweater_color”). The event database 210 preferably makes these associated data properties automatically available for queries; for example, the sweater color might be accessed by the field “e.sweater_id.sweater_color”. A column of derived implicit data is an example of a virtual column. A second example of a virtual column is a lookup column; the event database 210 can include direct access to the attribute fields, which can function to removes the need for table joins. Access to the attribute fields may be facilitated by importing tables declared as join tables. Declaring join tables preferably allows the join tables to be linked with the dimension of a related event data table. Join tables are preferably stored as attribute name-value pairs.

Finally, as discussed in the method 100, virtual columns may also be produced by named expressions (including flows, as well as metrics, cohorts, and sessions). While virtual column data (e.g., flow information) may be stored by the event database 210, additionally or alternatively virtual column data may only be stored in temporary memory and/or cached/aggregate values of virtual column data may be stored in the event database 210.

The event database 210 is preferably distributed across computers in a distributed computing system. Each node of the distributed computing system preferably stores a part of the data contained by the event database 210. This data is preferably stored in persistent memory (e.g. hard disk drives, flash memory), but some or all of the data may be additionally or alternatively stored in temporary memory (e.g. RAM). The data in the event database 210 is preferably further partitioned into data shards on each node. Shards are preferably both horizontal and vertical table partitions; data shards are preferably formed from the intersection of a subset of all rows and a subset of all columns of a data table. Each shard preferably contains at least time information, but may additionally or alternatively contain other information. Shards can be partitioned by time; for example, each data shard may contain a set of events that occurred over a particular 24 hour period. Shards may additionally or alternatively be partitioned by any other suitable information (e.g. UID, IP address, session ID, etc.). Shard partitioning is preferably done by the following rules: vertical partitions preferably include a fixed number of fields, and there are a fixed number of horizontal partitions for each vertical partition. For example, if a dataset includes a time field, a UID field, an IP address field, and a location field, the dataset may be vertically partitioned into three. The first vertical partition would include the time field and the UID field; the second would include the time field and the IP address field, and the third would include the time field and the location field. Then the dataset would be horizontally partitioned by day; if there is one week of data, this would be seven horizontal partitions. Thus, the data would be partitioned into twenty-one shards. Shard partitioning may additionally or alternatively be done automatically by any other rule set or algorithm or may be done manually.

Each shard preferably has a shard number (or other identifier), and each shard number is preferably stored, along with the node on which the shard exists, by the system 200. This linked data may be additionally or alternatively stored in any suitable location. Keeping a central list of shard and node links preferably enables the query executor 220 to determine the right node to query for particular data. The list of shard/node links may additionally include other information, such as a summary of data included in the shard.

Data on a shard is preferably further partitioned by folder; each folder contains data between two timestamps. Data may additionally be further partitioned by folder partitions, which allow data to be compacted within columns into smaller time-bound chunks (which may utilize columnar compression optimized for that data). Additionally or alternatively, data may be portioned in any manner.

The query executor 220 functions to process incoming queries on event data and return results of the queries. The query executor 220 preferably includes at least one of a query planner 221, a set aggregation engine 222, a per-actor aggregation engine 223, a flow annotation engine 224, a session annotation engine 225, and a result generator 226.

The query planner 221 functions to convert a query from a user into a set of instructions capable of providing a query result (as described in S120). The query planner 221 preferably divides instructions among the aggregation and annotation engines (as described in further detail below) as well as any of the other functions described in S120.

The set aggregation engine 222 functions to aggregate event streams into a single value according to an aggregation function (e.g., count(*), sum, mean, median, etc.). The set aggregation engine 222 preferably takes time range, aggregation function, compare groups, and filter conditions as inputs. As the engine 222 scans relevant columns for the requested time range, the aggregation engine on each node preferably updates its state accordingly.

The per-actor aggregation engine 223 is similar to the set aggregation engine 222, except that aggregation occurs per actor (rather than across actors for a given time interval). The per-actor aggregation engine 223 plays an important role for cohorts, per-actor metrics, and other internal query optimizations.

The flow annotation engine 224 functions to track flows in a substantially similar manner to that described in the method 100 (more specifically, S130).

The session annotation engine 225 tracks actor sessions (e.g., events linked to an actor within a continuous time period bounded by time limits and/or certain trigger events). The session engine 225, similar to the flow engine 224, is an annotation engine, and preferably updates session data during query performance and stores said session data in virtual columns.

The system 200 may include any number of instances of the engines 222, 223, 224, and 225 operating in parallel to process queries.

The result generator 226 functions to merge results from the engines 222, 223, 224, and/or 225 to produce query results as described in S140 (in multi-pass queries, the result generator 226 may also perform intermediate data calculations as described in S130).

The query executor 220 may additionally or alternatively perform data caching as described in S150. Note that the system 200 may maintain data caches based on changes to the event database 210; for example, as data is modified, resorted, resharded, etc. caches may need to be invalidated and/or updated.

The string lookup database 230 functions to store information linking strings to integers that uniquely identify the strings. The string lookup database 230 is used by the string translator 240 to translate strings to their respective integer identifiers and vice versa. The mapping of strings to identifiers in the string lookup database 230 is preferably stored in a manner that enables prefix matching (e.g. by use of a trie data structure), but may additionally or alternatively stored in any suitable manner. The string lookup database 230 is preferably distributed across computers in a distributed computing system. Each node of the distributed computing system preferably stores a part of the data contained by the string lookup database 230. This data is preferably stored in persistent memory (e.g. hard disk drives, flash memory), but some or all of the data may be additionally or alternatively stored in temporary memory (e.g. RAM). The data in the string lookup database 230 is preferably further partitioned into data shards on each node. The data shards of the string lookup database 230 preferably correspond to data shards of the event database 210, but may alternatively be partitioned independent of the partitioning of the event database 210.

Each field of the event database 210 preferably corresponds to independent string lookup data shards of the string lookup database 230. This enables the same integer identifiers to be used for different strings in different fields. The relationship between a string lookup data shard and a corresponding event database 210 field is preferably stored in a configuration database, but may alternatively be stored in any suitable location. If the string lookup data shards correspond to event data shards, the relationship may simply be that the two shards share a shard identifying number. The relationship between string lookup shards and event database 210 fields is preferably one-to-one, but alternatively may be any suitable relationship; for example, if two fields contain similar string data, (e.g. middle name and first name), they may share a string lookup shard.

The string translator 240 functions to convert strings in incoming event data to integer identifiers. Converting strings to integer identifiers can greatly save in the amount of space required to store event data, and can also optimize certain operations (preferably including operations used by the query executor 220). The string translator 240 preferably translates strings in received event data to string identifiers before event data is written to the event database 210, but may additionally or alternatively translate the strings to string identifiers at any suitable time. The string translator 240 preferably translates all strings in received event data, but may alternatively only translate a subset of all strings in received event data. The string translator 240 preferably translates a string by looking up an identifier corresponding with the string in the string lookup database 230. The corresponding identifier is preferably an identifier linked to the specific string, but the corresponding identifier may additionally or alternatively be linked to other data. For example, an identifier might only correspond to a string if the string has a particular value and the string is part of a particular field or type of event data. This enables identifiers to be reused for different data types; for example, the integer identifier “42” might correspond to the string “Canada” for data in a “Country” field and might correspond to the string “January” for data in a “Month” field. This “other data” may be explicitly present in the string lookup database 230 or may be implicitly present; for example, string lookup data may be stored in a different location (as described in the section on the string lookup database) if the string lookup data corresponds to a different event data field.

If the string has a corresponding identifier in the string lookup database 230, the string is translated into that identifier before being written into the event database 210. If the string does not have a corresponding identifier, a corresponding identifier is preferably created for the string. The corresponding identifier is preferably the next available identifier in the string lookup database 230; but may alternatively be chosen according to the string value. For example, all string values beginning with the letters a, b, or c may have an integer identifier starting with a “1”. If identifiers are chosen according to string value, identifier lookup data is preferably stored in a format that enables prefix matching.

The string translator 240 also functions to handle string translation for queries. When the query executor 220 receives a query, the strings in the query are preferably passed to the string translator 240 to be translated into identifiers. The query is preferably then processed using the identifiers. After the query has been processed, identifiers in the query result are preferably processed back into strings by the string translator 240, allowing the query results to be viewed or processed without further intervention from the string translator 240.

The methods of the preferred embodiment and variations thereof can be embodied and/or implemented at least in part as a machine configured to receive a computer-readable medium storing computer-readable instructions. The instructions are preferably executed by computer-executable components preferably integrated with a system for query processing. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A method comprising:
defining a first event flow structure that includes starting criteria, stopping criteria, a plurality of flow states, and state transition criteria;
identifying, in a received query, a reference to the first event flow structure;
tracking flows satisfying the first event flow structure within an event database that stores event data objects, comprising:
generating flow information for at least one flow,
wherein the tracking is performed in accordance with the starting criteria, the stopping criteria, and the state transition criteria of the first event flow structure, and
wherein the flow information identifies event data objects matching the first event flow structure and identifies a flow state for each matching event data object; and
calculating a query result based on the generated flow information.

2. The method of claim 1,
wherein each event data object stored in the event database has a time attribute, an actor attribute, and an action attribute,
wherein the flow information for a flow includes an identifier of the flow and a state of the flow at termination.

3. The method of claim 2, wherein for each flow, the flow information includes information indicating time spent in each flow state.

4. The method of claim 2, wherein for each flow, the flow information includes information indicating a result of at least one flow metric defined for the first event flow structure.

5. The method of claim 2, wherein the stopping criteria identifies a stopping state of the flow.

6. The method of claim 2, wherein the stopping criteria is a flow limit.

7. The method of claim 2, further comprising: providing the flow information to a user device via a network.

8. The method of claim 7, wherein tracking flows comprises: providing the flow information to a user device via a network, and before calculation of the query result.

9. The method of claim 7, wherein the flow information is provided as a data object.

10. The method of claim 7, wherein the flow information is displayed in a user interface provided to the user device, and wherein display of the flow information at the user interface is updated during tracking flows.

11. The method of claim 10, further comprising:
caching the query result data and the flow information;
receiving and interpreting a second query that includes a reference to flow information displayed at the user interface;
calculating a second query result for the second query by using the cached flow information; and
displaying the second query result in the user interface.

12. The method of claim 1,
wherein tracking flows comprises:
identifying a first set of data shards containing event data objects relevant to the first event flow structure,
collecting a first sample of event data objects from the first set of data shards,
tracking flows satisfying the first event flow structure within the first sample to generate flow information from the first sample,
identifying a second set of data shards from the flow information generated from the first sample, and
collecting a second data sample from the second set of data shards, wherein the query result is calculated based on the second sample.

13. The method of claim 1,
wherein tracking flows comprises:
identifying a first set of data shards containing event data objects relevant to the first event flow structure,
collecting a first sample of event data objects from the first set of data shards, wherein collecting the first sample comprises collecting event data objects from each of the first set of data shards,
tracking flows satisfying the first event flow structure within the first sample to generate flow information from the first sample,
analyzing the flow information generated from the first sample to identify a set of query-relevant data sources,
identifying a second set of data shards from the set of query-relevant data sources,
collecting a second sample from the second set of data shards, wherein collecting the second sample comprises collecting data from each of the second set of data shards, and
tracking flows satisfying the first event flow structure within the second sample to generate flow information from the second sample,
wherein the query result is calculated based on the flow information generated from the second sample.

14. The method of claim 1, further comprising: providing a user interface to a user device via a network, wherein the user interface includes at least one user interface element for receiving user input defining the first event flow structure, and wherein the first event flow structure is defined in response to receiving user input via the user interface.

15. The method of claim 14, wherein the user input specifies at least one flow metric.

16. The method of claim 15, wherein the user input specifies at least one flow breakpoint.

17. The method of claim 16, wherein the user input specifies at least one flow jump condition.

18. The method of claim 17, wherein the user input specifies a plurality of starting states each with starting criteria.

19. The method of claim 18, wherein the user input specifies a plurality of stopping states each with stopping criteria.

20. The method of claim 19, wherein at least one starting criteria of the first event flow structure matches at least one action of an event data object.
